(19) United States
(12) Patent Application Publication
(10) Pub. No.: US 2014/0006538 A1
(43) Pub. Date: Jan. 2, 2014

(54) Intelligent Client-Side Caching On Mobile Devices

(71) Applicant: Georgios Oikonomou, Rio (GR)

(72) Inventor: Georgios Oikonomou, Rio (GR)

(73) Assignee: Bytemobile, Inc.

(21) Appl. No.: 13/536,430

(22) Filed: Jun. 28, 2012

(51) Int. Cl. G06F 15/167

(52) U.S. Cl. 709/213

(57) ABSTRACT

Presented are systems and methods for receiving a content request from an application on a mobile device, and processing the content request to obtain a processed content request. The processed content request is compared to index metadata to determine the location of the content, and retrieving the content from the determined location. The cache index is then updated and the requested content is provided to the application.

### BACKGROUND INFORMATION

Mobile devices have evolved largely in the last few years, both in processing power and in storage space. Hundreds of thousands of mobile applications have appeared in recent years, suggesting that a new application ecosystem has emerged in which software runs on handheld, small-screen, battery-equipped devices.

Caching is one important element in any network oriented mobile service. Given the limited power that mobile devices have, retrieving content over the wireless network can be costly not only in terms of power consumption but also in financial terms. The wireless spectrum can be an expensive resource and mobile carriers tend to charge for use, thus discouraging abuse of network resources.

Many caching schemes currently exist and each technique serves best for a given purpose. These caching schemes are generally application specific requiring developers to create custom caching solutions for individual applications. Moreover, few caching systems are directed toward mobile devices, as mobile devices are a relatively new and emerging field for caching systems. Particular characteristics of this field are (i) different type of bearer networks on the same device (e.g., Wi-Fi and mobile network), (ii) limited processing power, (iii) small, but sufficient disk space to accommodate a cache system, and (iv) dependency on a limited power source.

### BRIEF DESCRIPTION OF THE DRAWINGS

FIG. 1 in block diagram form, is an example system utilizing a cache control system for managing mobile device cache.

FIG. 1B illustrates an example relationship between the cache control system depicted in FIG. 1A and other software layers.

FIG. 2A is a block diagram depicting exemplary cache control system.

FIG. 2B illustrates an example embodiment of remote storage provider configured to store content for one or more users.

FIG. 3 is a flowchart representing an exemplary method for retrieving content using a cache control system.

FIG. 4 is a flowchart representing an exemplary method for caching streaming content by a remote storage provider.

FIG. 5 is a flowchart representing an exemplary method for predictively populating a local cache with content performed by a cache control system.

FIG. 6 is a flowchart representing an exemplary method for retrieving content using a remote service provider in communication with a cache control system.

### DETAILED DESCRIPTION OF DRAWINGS

Reference will now be made in detail to the exemplary embodiments, the examples of which are illustrated in the accompanying drawings. Wherever possible, the same reference numbers are used throughout the drawings to refer to the same or like parts.

Some exemplary embodiments disclosed herein are directed to methods and systems for intelligent client-side caching on mobile devices using a cache control system. The cache control system extends the network connection layer, can be bundled as a library in mobile operating systems, and can be invoked by any application that requires caching. Additionally, apart from the typical objects, the cache control system can also cache streaming content, such as videos or music. Moreover, it has the ability to transparently and continuously learn and adapt to user browsing behavior, forming usage patterns, and proactively fetching objects. Additionally, in some embodiments, cache control system operates in conjunction with one or more remote storage providers. The remote storage providers can act to extend storage space for a mobile device. Additionally, the remote storage providers can optimize the content before delivering it to a mobile device.

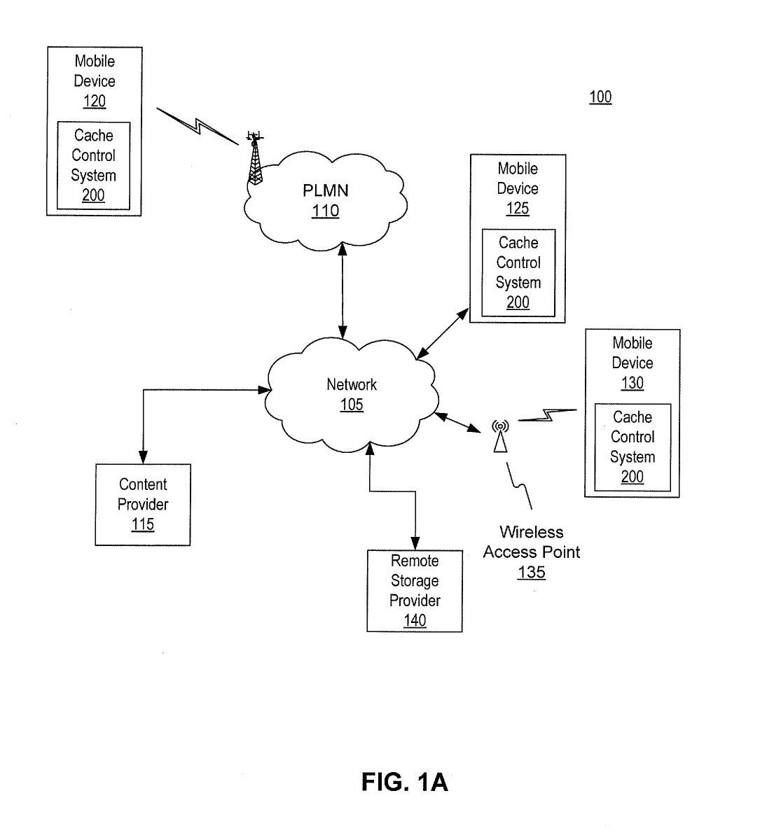

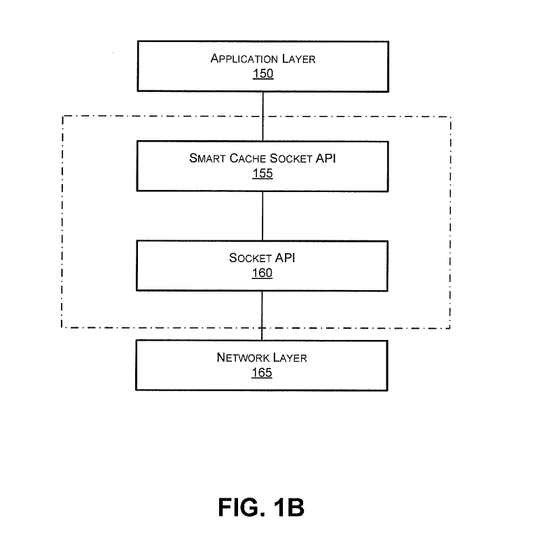

Reference is now made to FIG. 1A, which shows, in block diagram form, an example system utilizing a cache control system for managing mobile device cache, generally designated 100. System 100 can include a network 105, a public land mobile network (PLMN) 110, a content provider 115, client devices 120, 125, and 130, a wireless access point 135, and a remote service provider 140.

Network 105 can be, for example, the Internet, an intranet, a local area network, a wide area network, a campus area network, a metropolitan area network, an extranet, a private extranet, any set of two or more coupled electronic devices, or a combination of any of these or other appropriate networks. Network 105 can also communicate with PLMN 110, which is also referred to as a wireless wide area network (WWAN) or, in some cases, a cellular network.

Content provider 115 can be one or more computer servers that receive a request for media content from mobile devices 120, 125, and 130, remote storage provider 140, or some combination thereof, process the request, and provide media content to the requester through, network 105. For example, content provider 115 can be a web server, enterprise server, or any other type of computer server. Content provider 115 can be one or more computers programmed to accept requests (e.g., HTTP or other non-streamable protocols) from and to serve content to mobile devices 120, 125, and 130, remote storage provider 140, or some combination thereof. Content may include, for example, text, audio data, video data, streamable data, and non-streamable data. Also, content provider 115 can be a PDA, cell phone, laptop, desktop, or any device configured to transfer media content to mobile devices 120, 125, and 130, remote storage provider 140, or some combination thereof, through network 105. In addition, content provider 115 can be broadcasting facilities, such as free-to-air, cable, satellite, and other broadcasting facilities, for distributing media content to mobile devices 120, 125, and 130, remote storage provider 140, or some combination thereof. Further, content provider 115 can be video sources, such as surveillance devices configured to capture videos and transfer the captured videos to mobile devices 120, 125, and 130, remote storage provider 140, or some combination thereof.

System 100 can include a number of mobile devices, for example, mobile devices 120, 125, and 130. Mobile devices 120, 125, and 130 can be, for example, smartphones, or tablets. Mobile devices 120, 125, and 130 can include devices equipped for cellular communication through PLMN 110, devices equipped for Wi-Fi communications using wireless access point 135, or dual-mode devices capable of both cellular and communications using network 105, or any combination thereof. Wireless access point 135 can be configured to WLANs that operate in accordance with one of the IEEE 802.11 specifications. For example, mobile device 130 is coupled wirelessly to network 105 using wireless access point 135, and mobile device 120 is coupled to network 105 via PLMN 110. Mobile devices 120, 125, and 130 can be equipped for Wi-Fi communications. In this embodiment, mobile devices 120, 125, and 130 each include an associated cache control system 200.

Mobile devices 120, 125, and 130 can include one or more processors (not shown), a memory (not shown), and a data interface (not shown). The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs. While portions of the specification only refer to one mobile device 120, 125, or 130, this is for simplification purposes only and, unless noted otherwise, is not meant to limit the described embodiments in any way.

Mobile device 120, 125, or 130, each have a respective cache control system 200. Alternatively, the methods can be implemented in hardware components or combinations of hardware and software such as, for example, ASICs. In some embodiments, cache control system 200 is in communication with and operates as part of a single cache control system installed on mobile devices 120, 125, or 130, and other servers on the network 105, for example, remote storage provider 140. Additionally, cache control system 200 can be coupled to content provider 115, remote storage provider 140, or some combination thereof. In some embodiments not shown, cache control system 200 may also couple to one or more other mobile devices via network 105, PLMN 110, wireless access point 150, or some combination thereof.

Cache control system 200 is configured to manage what content is stored in a local cache of an associated mobile device. Additionally, in some embodiments, cache control system 200 is also configured to manage what content is stored in a remote cache that is associated with the user of the mobile device and stored by remote storage provider 140. As discussed in detail below, cache control system 200 may also he configured to analyze a user's content usage patterns to proactively retrieve content and store it in the local cache prior to the user actually requesting it.

System 100 can include remote storage provider 140. Remote storage provider 140 is one or more servers that are configured to provide extra storage space for content to be cached for each mobile device. In some embodiments, remote storage provider 140 may be part of an internet service provider (not shown), a mobile carrier (not shown), a cloud computing solution, or a user terminal (e.g., desktop computer, laptop computer, etc.). In some embodiments not shown remote storage provider 140 is not included as part of system 100.

Mobile devices (e.g., 120, 125, and 130) generally have limited local storage space. Remote storage provider 140 is configured to communicate with cache control system 200 to store content downloaded from content provider 115 or other content providers (not shown), other remote storage providers (not shown), one or more mobile devices 120, 125, and 130, or some combination thereof. Remote storage provider 140 stores the downloaded content in the remote cache associated with the user of the mobile device. Remote storage provider 140 is also configured to provide, upon request from cache control system 200, any content that is stored in the remote cache to the cache control system 200 of the requesting mobile device. Content stored in the remote cache is also known as remote cached content.

Remote storage provider 140 can include one or more processors (not shown), a memory (not shown), and a data interface (not shown). The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers. Remote storage provider 140 can be implemented on a single computer, or in some instances be distributed across a plurality of computers. Remote storage provider 140 can be coupled to one or more of mobile devices 120, 125, and 130, content provider 115, or some combination thereof, via network 105. In some embodiments not shown, remote storage provider 140 is coupled to one or more mobile devices 120, 125, and 130 directly or via Wi-Fi. Remote storage provider 140 is discussed in detail below.

Cache control system 200 provides a framework solution for caching contents on a mobile device taking into account the limitations of the platform. This framework can be implemented as an intermediate layer between the socket and the application layer, thus extending the socket layer of the mobile platform with extra methods that implement the cache functionality. FIG. 1B illustrates an example relationship between a cache control system and other software layers. Generally, a socket application programming interface (“API”) 160 is positioned between an application layer 150 and a network layer 165. In this embodiment, cache control system 200 may be implemented as a smart cache socket API 155 that extends socket API 160, such that smart cache socket API 155 is positioned between application layer 150 and socket API 160. Cache control system 200 can thus be integrated transparently into an application. Additionally, cache control system 200 may be packaged as a library that can be called by any application, providing exclusive or shared use of the cache contents. Additionally, cache control system 200 may provide different caching strategies that match different application requirements. Additionally, because smart cache socket API 155 operates as an extension to socket API 160, it possesses all methods of a typical socket layer and introduces additional configuration methods. Typical methods of the socket layer include: opening/closing a network connection, reading/writing data buffers from/to the network, check current status, report any errors in connection, etc.

As noted above, cache control system 200, in addition to inheriting the typical methods of the socket layer, also adds additional configuration methods that can be applied on a per-application basis. Because cache control system 200 works as a layer in the mobile programming ecosystem, it is not application specific. Accordingly, application developers are able to utilize cache control system 200 to implement a cache solution without having to develop custom caching solutions on a per-application basis. Additionally, because cache control system 200 inherits and extends the socket layer methods, if an application developer needs to add caching immediately to an application, the developer could easily replace the application's native caching class with a caching class corresponding to cache control system 200. Developers are thus allowed to alter one or more parameters so that their applications integrate with cache control system 200. Additionally, in some embodiments, users of mobile devices may alter parameters associated with one or more applications on their mobile devices to customize operation or bypass cache control system 200. Parameters may include, for example, a constructor parameter, a cache mode parameter, a cache size parameter, a cache strategy parameter, a cache sharing parameter, a cache contents parameter, and a cache network parameter.

The constructor parameter may be used to initialize the cache and create a unique instance for the scope of the current application. The constructor parameter includes the application name as an argument. Additionally, the constructor parameter may include some user authentication information. The user authentication information may be used, for example, in requests to access content in a remote storage provider.

The cache mode parameter defines the one or more caches that are going to be used by cache control system 200. The one or more caches can be the local cache only, the remote cache, or some combination thereof. In some embodiments, the cache parameter can define that no cache will be used by cache control system 200.

The cache size parameter defines the maximum storage space of the local cache, the remote cache, or both, for a specific application. In case the contents size increases beyond this limit, a cache strategy parameter is used to determine what data should be removed from the local cache or the remote cache.

The cache strategy parameter provides instruction as to how content should be loaded and maintained by cache control system 200. Example cache strategies can include discarding least recently used content, loading content to cache based on usage pattern (e.g., see usage patterns module discussed below), and discarding least frequently used items. It is appreciated that other cache strategies can be implemented.

The cache sharing parameter defines if the local or the remote cache contents can be shared with other applications.

Cache contents parameter identifies the types of files that may be stored in the local cache, the remote cache, or both. For example, the cache contents parameter indicates that the cache is able to store text, images, any non-text file (e.g., Flash application), streaming data (e.g., content transported with RTP and RTMP protocols), any type of file, or some combination thereof. Text-based content may include HTML, XML, CSS, Javascript, or any other text formatted object retrieved through the Internet connection.

Cache network parameter indicates when cache control system 200 is active based on the underlying network. For example, cache network parameter may indicate that cache control system 200 is active when the mobile device is operating using a Wi-Fi network, a cellular network (e.g., 2G/3G/LTE) where data charges apply, a cellular network with a flat data plan, or some combination thereof.

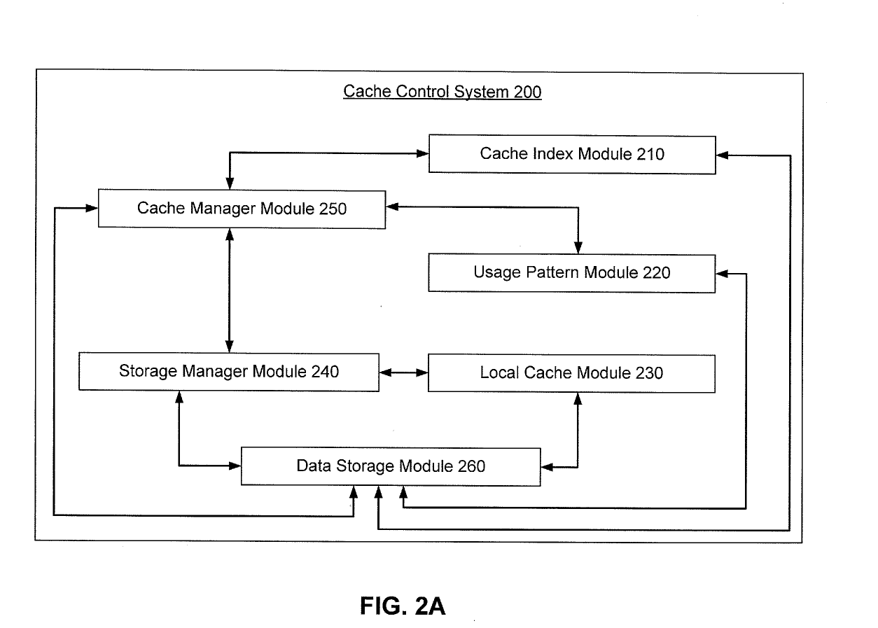

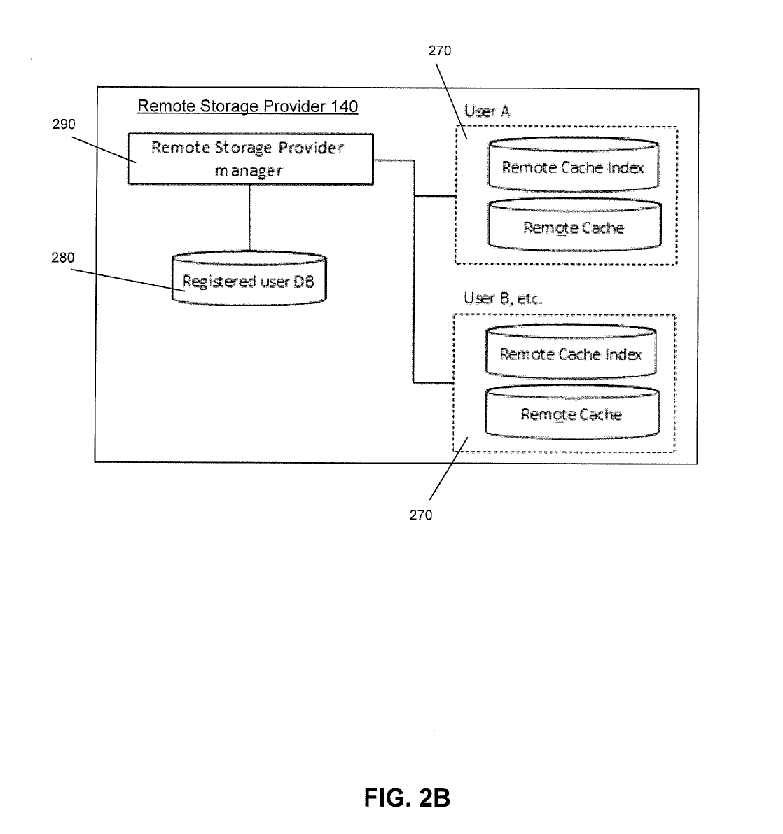

FIG. 2A is a block diagram depicting exemplary cache control system 200. Cache control system 200 may include a cache index module 210, a usage patterns module 220, a local cache module 230, a storage manager module 240, a cache manager module 250, and a data storage module 260.

Cache index module 210 is a hardware component, a software program, or a combination thereof configured to store index metadata in a cache index. The index metadata is associated with content stored in a cache (e.g. local or remote), such that a combination of a portion of the index metadata is uniquely keyed to a piece of corresponding content. The index metadata is used by cache manager module 250 to determine content status, and provide appropriate instructions to storage manager module 240. Content status indicates whether the stored content is expired or needs to be refreshed. Cache index module 210 stores the index metadata in the cache index using a variety of fields. The fields may include the following:
Content ID: a unique identifier for each piece of content.
Application name: the application that initiated the request (defined when cache was initialized).
First retrieval timestamp: the timestamp of the first retrieval date of the content.
Last access timestamp: the timestamp of the latest retrieval of the content.
Total retrieval counter: the number of times this content has been accessed while being in the cache.
Type of content: For example, the content may be text, audio, image, video, streaming content, etc.
Content size: the size of the piece of content in the cache.
Storage Index ID: a pointer to the unique Storage Index identifier.
Host name: the destination host name of the request.
IP: the destination IP address of the request.
Port: the destination port.
Protocol: the protocol used, e.g. HTTP, HTTPS, or unknown if not explicitly defined.
Cache Strategy: the cache strategy that applies for the content.
Remote storage provider: in case a remote storage provider exists, the provider information.
Checksum: the checksum of the content. This may be used to identify modified versions of the same content. For example, several changes in the checksum for the same content denote non-static content that is updated often, thus indicating that caching should not be applied. A message-digest hash function algorithm (e.g., MD5) may be used to calculate the checksum.
Compression factor: indicates the type and amount of compression used to store the cached content. The compression may be lossy or lossless.
Error code or exception (if applied): in case an error occurred. For example, an error may occur if some or all of the content is corrupted.
Cost of the request: the inverse of the speed to service the request multiplied by a mobility factor, i.e. a 3G network costs more than a Wi-Fi network, a roaming network costs more than a domestic, etc.
   The cache index module 210 may be coupled the cache manager module 250, and data storage module 260.

Usage pattern module 220 is a hardware component, a software program, or a combination thereof configured to store some higher-level information about requests for content and extract some conclusions over the cache usage. Additionally, usage patterns module 220 is configured to monitor all the registered applications on the mobile device and periodically aggregate the request history based on, for example, a time series analysis or a machine learning algorithm. Usage patterns module 220 may also be disabled or enabled by the user, a developer, or both, by adjusting the cache strategy parameter value.

Usage pattern module 220 contains a chronological sequence of all the requests, otherwise known as request history, for content from cache control system 200 over time. For example, usage pattern module 220 may contain a chronological sequence of the cache index IDs (i.e. specific index metadata associated with a piece of content) requested by an application. Usage pattern module 220 is configured to analyze request history to determine any periodic variation or specific trends in content requests. The identified content requests can then be provided to cache manager module 250 for proactive retrieval to ensure the content is in the local cache when the actual request for content is received by cache control system 200. For example, an application may periodically access a user's social network profile (e.g., FACEBOOK). Usage pattern module 220 is configured to detect any repeated usage pattern (e.g., accessing FACEBOOK page every evening), and preemptively retrieve and store content associated with expected requests for content in local cache module 230 (retrieving again if needed) so that it is available around the time of day that the application is most likely to access this information. Usage pattern module 220 may also be configured to monitor and refresh data stored in local cache module 230. Additionally, in some embodiments, usage pattern module 220 may take into account the cost associated with proactive caching of content. For example, if the content costs more to proactively retrieve, then cache control system 200 is configured to retrieve the content from a content storage provider after the content request is received from an application.

Additionally, in some embodiments, usage pattern module 220 monitors one or more networks available to the user's mobile device. If there are a plurality of networks available (e.g., Wi-Fi and cellular), usage pattern module 220 may be configured to select a network, of the plurality of networks, to retrieve content (e.g., from a content service provider or a remote service provider) based on bandwidth of the network, cost of usage for that network, user selection, or some combination thereof. The usage pattern module 220 may be coupled to the cache manager module 250, and data storage module 260.

Local cache module 230 is a hardware component, a software program, or a combination thereof configured to store downloaded content. Local cache module 230 includes a local cache, which may be, for example, a secure digital (“SD”) card, an internal NAND memory, or any other external device that provides storage capabilities. Local cache module 230 may be configured to organize the stored content using a hashing algorithm, e.g., SHA1 cryptographic hash algorithm. Local cache module 230 may key stored content using a unique combination of the associated index metadata stored in the cache index. For example, local cache module 230 can be configured to apply the hashing algorithm to the request URL, the requester's username, or some combination thereof, to create a unique key that corresponds to the requested content. The content stored in the local cache may be organized based off this key, e.g., in order of key value.

Local cache module 230 is configured to store content as files in the local cache. The stored content may be accessible by a file exploring application. For example, an unencrypted image file stored in the local cache may be accessible by an ASTRO FILE MANAGER, or some other third party file manager, on an ANDROID mobile device. Additionally, in some embodiments, local cache module 230 is configured to encrypt content stored in the local cache using, for example, asymmetric or symmetric encryption methodologies. Local cache module 230 is configured to store text, images, any non-text file (e.g., Flash application), streaming data (e.g., content transported with RTP and RTMP protocols), any type of file, or some combination thereof, in the local cache.

Additionally, in some embodiments, when stored streaming content is retrieved from a local cache to be provided to a requesting application cache control system 200 can be configured to change the packet sequence numbers, timestamps, etc., in order to be playable by the requesting application. The requesting application may be, for example, on the same mobile device as cache control system 200, or a different mobile device. For example, if a file was streamed to cache control system 200 in 1000 different packets, cache control system 200 is configured to store the 1000 packets in the local cache, maintaining the same number of packets, and timing information for each packet. When cache control system 200 processes a request to provide the stored video file to a requesting application, cache control system 200 updates the timing information in each stored packet and then streams the 1000 packets to the requesting application in the same manner (e.g., timing between packets and number of packets is the same) as the data file was originally cached.

Local cache module 230 may be coupled to storage manager module 240 and data storage module 260.

Storage manager module 240 is a hardware component, a software program, or a combination thereof, configured to manage the actual cache contents stored in the local cache, one or more remote storage providers (e.g., remote storage provider 140), or both. Additionally, storage manager module 240 is configured to retrieve content from a content provider (e.g., content provider 115) and store the retrieved contents in the local cache. Storage manager module 240 accepts processed content requests from cache manager module 250 and interacts with the network local cache module 230, one or more remote storage providers (e.g., remote storage provider 140), or both, to fulfill the request. Processed content requests are content requests received from an application that have been parsed by cache manager module 250 to obtain portions of index metadata, the combination of which is uniquely keyed to the requested content.

Storage manager module 240 is configured to read the processed content request and cache index information to determine whether the requested content is stored in the local cache, one or more remote storage providers, a content provider, or some combination thereof. Additionally, storage manager module 240 is configured to determine if the index metadata reflects the actual status of the content in the cache. For example, if the stored content has been modified since the last time it was accessed, the storage manager module 240 is configured to retrieve the content again from the content provider. In case of an error, storage manager module 240 may return an appropriate error code or exception to cache manager module 250.

In some embodiments, storage manager module 240 is configured to produce a delivery report after content is either retrieved from the content provider, a remote storage provider, or the local cache. Storage manager module 240 may be configured to distribute the delivery report to cache index module 210, usage pattern module 220, or some combination thereof. The delivery report contains information (e.g., total download size, the time to complete, and any error encountered) used to update the time stamps and the index metadata stored in the cache index module 210 and usage pattern module 220.

In some embodiments, storage manager module 240 may be configured to instruct other modules (e.g., local cache module 230) to perform compression on some or all of its stored data. For example, storage manager module 240 may be configured to instruct local cache module 230 to compress items accessed less frequently (e.g., weekly vs. daily). Storage manager module 240 can be configured to indicate whether lossless or lossy compression of data should be used.

Additionally, storage manager module 240 may be configured to instruct local cache module 230 to perform compression on some or all of its stored content depending on a predicted compression ratio. The predicted compression ratio is the predicted compressed data size divided by the uncompressed data size. For example, if the predicted compression ratio for content is close to 1 (i.e., little or no compression would occur), storage manager module 240 is configured to not instruct local cache module 230 to perform compression on the content. In contrast, if the predicted compression ratio is, for example, 0.75 or less, storage manager module 240 may be configured to instruct local cache module 230 to perform compression on the content. Storage manager module 240 may be coupled to local cache module 230, cache manager module 250, and data storage module 260.

Cache manager module 250 is a hardware component, a software program, or a combination thereof configured to receive content requests (e.g., API calls) from one or more applications and return the requested content. The request for content also may contain a destination host, a destination port, protocol details (e.g., additional HTTP headers), or some combination thereof.

Cache manager module 250 is configured to parse the request for content. The cache manager module is configured to apply a hashing algorithm (e.g., SHA1 cryptographic hash algorithm) to portions of the parsed request for content to create a unique key (processed content request) that corresponds to the requested content. For example, cache manager module 250 can be configured to apply the hashing algorithm to the request URL, the requester's username, or some combination thereof, to create the processed content request that corresponds to the requested content. Cache manager module 250 is configured to compare the processed content request with index metadata stored in cache index module 210 to determine whether the requested content is stored in the local cache, one or more remote service providers, or must be downloaded from a content provider. Cache manager module 210 is configured to then instruct storage manager module to retrieve the content from the appropriate location. Additionally, cache manager module 250 is configured to instruct usage pattern module 220 to record the content request. After a request for content has been completed, cache manager module 250 is configured to instruct cache index module 210 to update the cache index.

Cache manager module 250 can be instantiated as a singleton within the application context to avoid repeated calls for the construction process. Cache manager module 250 is configured to retrieve an identifier associated with the requesting application. The identifier is used by cache control system 200 to distinguish separate processes and their access rights. Cache manager module 250 can also retrieve the user information from the application for creating unique profiles in one or more remote service providers.

Cache manager module 250 may also be configured to alter one or more parameters to configuration operations of cache control system 200 on a per-application basis. For example, developers may alter one or more parameters so that their applications integrate with cache control system 200. Additionally, in some embodiments, users of mobile devices may alter parameters associated with one or more applications on their mobile devices to customize operation or bypass cache control system 200. As discussed above, parameters may include, for example, a constructor parameter, a cache mode parameter, a cache size parameter, a cache strategy parameter, a cache sharing parameter, a cache contents parameter, and a cache network parameter. Cache manager module 250 may be coupled to cache index module 210, usage pattern module 220, storage manager module 240, and data storage module 260.

Additionally, in some embodiments cache manager module 250 monitors one or more networks available to the user's mobile device. If there are a plurality of networks available, cache manager module 250 may be configured to select a network, of the plurality of networks, to retrieve content (e.g., from a content service provider or a remote service provider) based on bandwidth of the network, cost of usage for that network, user selection, or some combination thereof.

In some embodiments, cache manager module 250 may be configured to actively monitor available network bandwidth between a content provider, a remote storage provider, or some combination thereof, and the user's mobile device. If the available network bandwidth drops below a transmission threshold during the download of content to the user's mobile device (from a content provider, a remote storage provider, or another mobile device), cache manager module 250 may be configured to automatically pause download of the content. After the available network bandwidth rises above the transmission threshold, cache manager module 250 may be configured to resume download of the content. The transmission threshold may be automatically determined by cache manager module 250. For example, cache manager module 250 may set the transmission threshold such that the content being stored in the local cache has undergone no lossy compression.

Data storage module 260 may comprise a random access memory (RAM), a read only memory (ROM), a programmable read-only memory (PROM), a field programmable read-only memory (FPROM), or other dynamic storage device for storing information and instructions to be used by cache index module 210, usage pattern module 220, local cache module 230, storage manager module 240, cache manager module 250. For example, data storage module 260 may store configuration information for cache control system 200. Data storage module 260 may also include a database, one or more computer files in a directory structure, or any other appropriate data storage mechanism such as a memory. In some embodiments, data storage module 260 is distributed across a plurality of different data storage mechanisms.

The coupling between modules, or between modules and network 105, may include, but is not limited to, electronic connections. Coupling may also be accomplished by communicating control information or data through one or more networks to other data devices. In some embodiments (not shown), cache index module 210, usage pattern module 220, local cache module 230, storage manager module 240, cache manager module 250, and data storage module 260 may be coupled in a manner such that each module is logically connected to all of the other modules in cache control system 200.

Each of the logical or functional modules described above may comprise multiple modules. The modules may be implemented individually or their functions may be combined with the functions of other modules. Further, each of the modules may be implemented on individual components, or the modules may be implemented as a combination of components. For example, cache index module 210, usage pattern module 220, storage manager module 240, cache manager module 250, may each be implemented by a field-programmable gate array (FPGA), an application-specific integrated circuit (ASIC), a complex programmable logic device (CPLD), a printed circuit board (PCB), a combination of programmable logic components and programmable interconnects, single CPU chip, a CPU chip combined on a motherboard, or any other combination of devices or modules capable of performing the tasks of modules 210, 220, 240, 250, and 260 on a mobile device.

FIG. 2B, illustrates an example embodiment of remote storage provider 140 configured to store content for one or more users. Remote storage provider 140 includes one or more user modules 270, a registered user database (“DB”) 280, and a remote storage provider (“RSP”) manager 290. In this embodiment, remote storage provider 140 is configured to store content for a user A and a user B. Each user has an associated user module 270. Within each user module there is a remote cache index and a remote cache. The remote cache index is a repository of content index metadata that is currently stored in the associated remote cache. The remote cache index may store data similar to that of cache index module 210 described above.

Registered user DB 280 contains authentication information for users of remote storage provider 140. Authentication information may include one or more encryption keys, user-IDs, passwords, etc., that are used to authenticate a request for content from a specific user's cache control system.

RSP manager 290 is configured to accept processed content requests from cache control system 200, and interact with registered user database 280 to authenticate the request. RSP manager 290 is configured to compare the processed content request with the index metadata stored in the user's remote cache index. If there is a match, RSP manager 290 transmits the content to the requesting cache control system. If there is not match, RSP manager 290 may be configured to return an appropriate error code or exception to cache control system 200. Alternatively, RSP manager 290 may be configured to retrieve the missing content, store it in the remote cache associated with the user, and transmit the retrieved content to the requesting cache control system.

Additionally, RSP manager 290 may be configured to periodically determine if the index metadata reflects the actual status of the content stored in each remote cache. For example, if the stored content has been modified since the last time it was accessed, RSP manager 290 may be configured to retrieve the content again from the content provider. Thus, keeping the cached content in each remote cache up-to-date.

Remote storage provider 140 may be configured to actively monitor the available network bandwidth between the content provider and one or more mobile devices (e.g., mobile devices 120, 125, 130). If during the download of content from the content provider to the one or more mobile devices, the available network bandwidth drops below a transmission threshold, remote storage provider 140 may be configured to automatically pause download of the content. After the available network bandwidth rises above the transmission threshold, remote storage provider 140 may be configured to resume upload of the content. The transmission threshold may be automatically determined by the remote storage provider 140. For example, remote storage provider 140 may set the transmission threshold such that the content being stored in the remote cache has undergone no lossy compression.

Additionally, remote storage provider 140 is configured to cache streaming data in the same format in which it is received. For example, if a file was streamed to remote storage provider 140 in 1000 different packets, remote storage provider 140 is configured to store the 1000 packets in the remote cache, maintaining the same number of packets, and timing information for each packet. When remote storage provider 140 processes a request to provide the stored video file, the remote storage provider updates the timing information in each stored packet and then streams the 1000 packets to the requesting device in the same manner (e.g., timing between packets and number of packets is the same) as the data file was originally cached.

In alternate embodiments, remote storage provider 140 is configured to store the 1000 packets as a complete data file. In this embodiment, remote storage provider 140 creates index metadata that allows retransmission of the data filed in the manner (e.g., same timing between packets and number of packets is the same) it was received.

Remote service provider 140 may be configured to encrypt content stored in one or more user modules 270. The encryption methodology may be, for example, asymmetric or symmetric encryption methodologies. Additionally, in some embodiments, remote storage provider 140 is configured to couple to one or more cache control systems 200 via a secure channel, e.g., an HTTPS connection, or a virtual private network. Additionally, in some embodiments, content may undergo lossless compression before being written to a remote cache.

Remote service provider 140 may be configured to accept proxy authenticated requests from a cache control system to the Internet. For example, cache control system may encapsulate the content request with a custom protocol that includes some extra metadata information for updating the remote cache index. For example, cache control system instruct remote service provider 140 to make download content and update its remote cache.

Remote service provider 140 may also be configured to pre-process content before transmitting it to a requesting cache control system. Pre-processing can include, for example, reducing audio quality, reducing image quality, reducing video quality, discarding content that cannot be displayed properly on the specific mobile device, or some combination thereof. Remote service provider 140 may be configured to monitor available network bandwidth between itself and the requesting cache control system. And remote service provider 140 may be configured to use optimization techniques to adjust the transmission bitrate of content to the requesting cache control system based on the available network bandwidth. The transmission bitrate may be adjusted by, for example, dropping frames, performing compression (lossy or lossless), or some combination thereof. The use of optimization techniques can be triggered by using an extra instruction header when sending a request for content from cache control system 200 to remote service provider 140. After the content is retrieved and processed, the optimization factor is returned to cache control system 200, as a response header, for being stored in the associated cache index module.

Remote storage provider 140 may be configured to backup a user's caching profile among different mobile devices. A cache profile includes, for example, the cache control system parameter configuration for one or more applications, content stored in local cache, data stored in the cache index, or some combination thereof. Additionally, remote storage provider 140 may be configured to periodically backup a user's cache index module, usage pattern module, or both, from the user's mobile device. For example, at regular intervals, copies of user's cache index module, usage pattern module, or both can be uploaded to remote storage provider 140. Remote storage provider 140 may be configured to transmit the backup cache index module, usage pattern module, or both to a mobile device at the user's request.

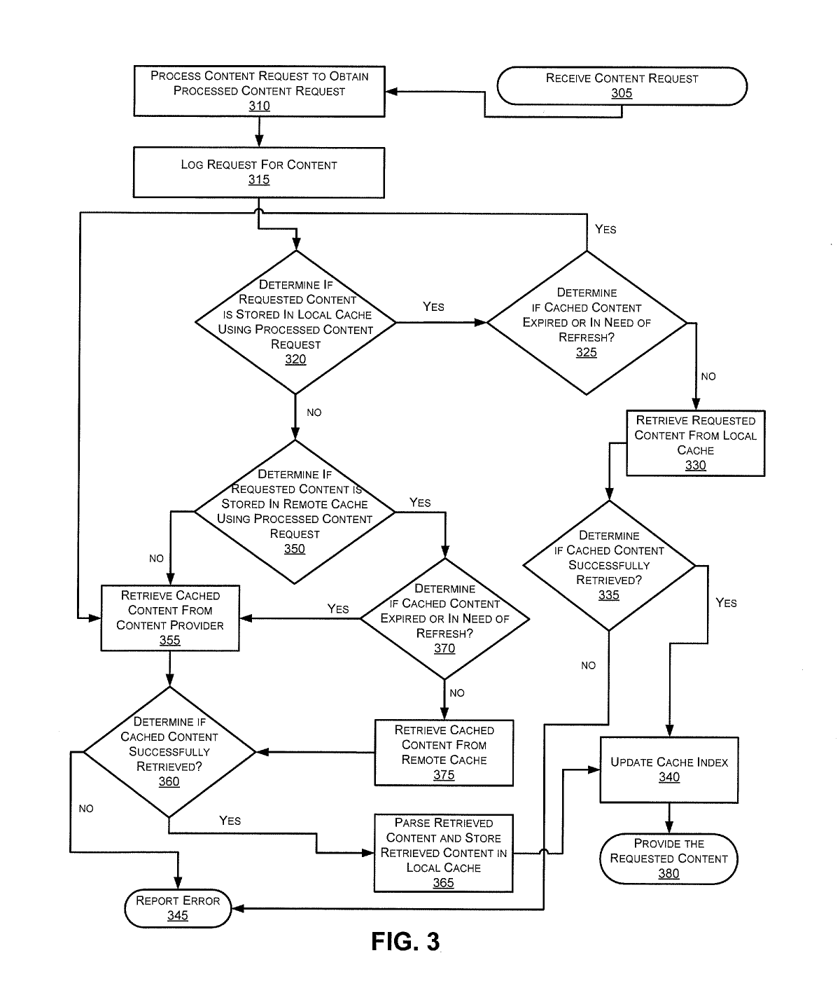

FIG. 3 is a flowchart representing an exemplary method for retrieving content using a cache control system (e.g., cache control system 200). Without departing from the exemplary embodiments, the exemplary process flow can be altered to delete steps, change the order of steps, or include additional steps.

The cache control system receives (305) a content request from an application operating on a user's mobile device. The requested content may be, for example, text, images, any non-text file (e.g., Flash application), streaming data (e.g., content transported with RTP and RTMP protocols), any type of file, or some combination thereof. The cache control system then processes (310) the content request to obtain a processed content request. The cache control system then logs (315) the content request in a user patterns module.

The cache control system then determines (320) if the requested content is stored in the local cache using the processed content request. For example, the cache control system can compare the processed content request with index metadata stored in a cache index to determine whether the requested content is stored in local cache. If the processed content request matches a corresponding index metadata in the cache index, then the requested content is stored in the local cache. The cache control system then determines (325) if the requested content stored in the local cache has expired or is in need of refresh. For example, the cache control system can evaluate the stored index metadata to determine if the content has expired (e.g., an expiration date of the content has passed, content has been erased, etc.).

If the stored content has expired or is in need of refresh, the cache control system retrieves (355) the cached content from a content provider. Additionally, in some embodiments the cache control system monitors the one or more networks available to the user's mobile device. If there are a plurality of networks (e.g., Wi-Fi, cellular, etc.) available to the mobile device, the cache control system may select a network, of the plurality of networks, based on bandwidth of the network, cost of use for that network, user selection, or some combination thereof. The cached content may then be retrieved from the content provider using the selected network.

The cache control system then determines (360) whether the requested content was successfully retrieved. Occasionally, requested content may be corrupted, or some other problem may occur which prevents successful retrieval of the requested content from the storage location. If the requested content is not successfully retrieved, cache control system reports (345) an error to the application. If the content is successfully retrieved at determination step 360, the cache control system stores (365) the retrieved content in the local cache and parses the retrieve content to obtain index metadata. The cache control system updates (340) the cache index with the index meta-data and provides (380) the requested content to the application.

Referring back to step 325, if the stored content has not expired or is not in need of refresh, the cache control system retrieves (330) the requested content from the local cache. The cache control system then determines (335) whether the requested content was successfully retrieved. Occasionally, requested content may be corrupted, or some other problem may occur that prevents successful retrieval of the requested content from the storage location. If the requested content is not successfully retrieved, cache control system reports (345) an error to the application. If the content is successfully retrieved, the cache control system updates (340) the cache index with the retrieval time and provides (380) the requested content to the application.

Referring back to step 320, if the cache control system determines that the requested content is not stored in the local cache, the cache control system then determines (350) if the requested content is stored in a remote cache using the processed content request. For example, the cache control system can compare the processed content request with index metadata stored in a remote cache index to determine whether the requested content is stored in remote cache. If the requested content is not stored in the remote cache, the method proceeds to step 355. If, the requested content determines that the requested content is stored in the remote cache, the cache control system then determines (370) whether the remote cached content is expired or in need of refresh. If the remote cached content is expired or in need of refresh the method moves to step 355. Otherwise, the cache control system retrieves (375) the remote cached content from the remote service provider.

Additionally, in some embodiments the cache control system monitors the one or more networks available to the user's mobile device. If there are a plurality of networks (e.g., Wi-Fi, cellular, etc.) available to the mobile device, the cache control system may select a network, of the plurality of networks, based on bandwidth of the network, cost of use for that network, user selection, or some combination thereof. The cached content may then be retrieved from the remote storage provider using the selected network.

The method then moves to step 360, and proceeds as discussed previously.

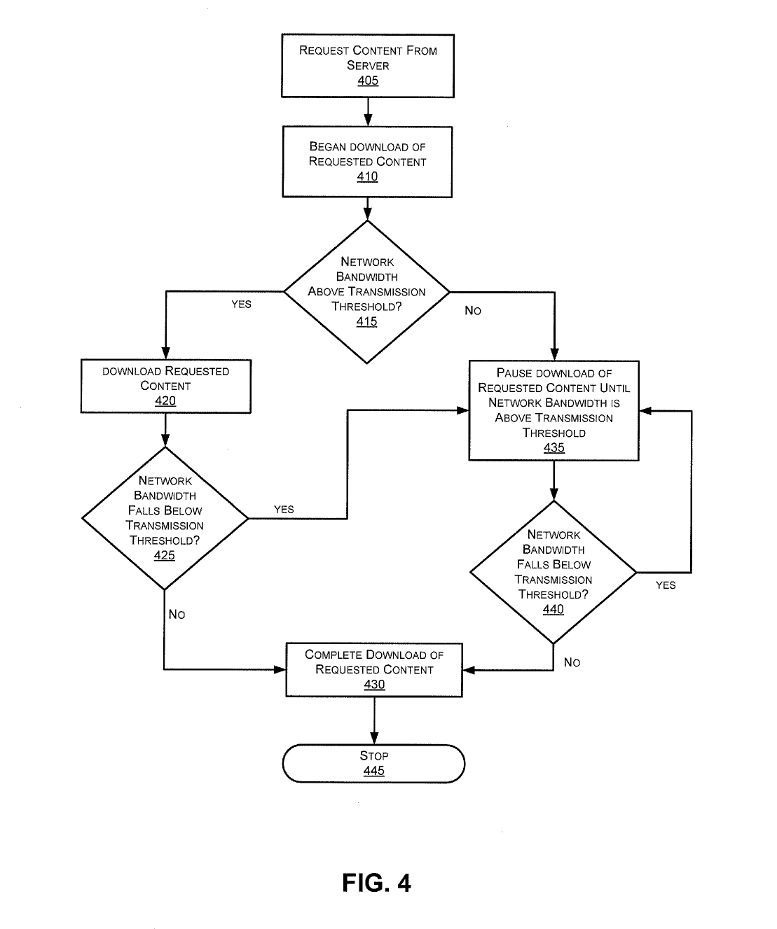

FIG. 4 is a flowchart representing an exemplary method for caching streaming content by a remote storage provider (e.g., remote storage provider 140). Without departing from the exemplary embodiments, the exemplary process flow can be altered to delete steps, change the order of steps, or include additional steps. Additionally, in some embodiments not shown, the functionality depicted in FIG. 4 can be implemented by a cache control system operating on a mobile device (e.g., mobile device 120, 125, or 130) in lieu of the remote storage provider. This may occur, when, for example, the remote storage provider is not present, not active, etc.

Remote storage provider requests (405) content from a server. Content may include, for example, text, images, any non-text file (e.g., Flash application), streaming data (e.g., content transported with RTP and RTMP protocols), any type of file, or some combination thereof. The remote storage provider 405 then begins download (410) of the requested content.

The remote storage provider then determines (415) if the available network bandwidth is above a transmission threshold. If the available network bandwidth is above the transmission threshold the requested content begins to download (420).

During the download, the remote storage provider continually monitors the available network conditions and determines (425, 440) if the available network bandwidth is above the transmission threshold. If during the download, the available network bandwidth drops below the transmission threshold the remote storage provider pauses (435) download of the content until the available network bandwidth is above the transmission threshold. After the available network bandwidth rises above the transmission threshold the remote storage provider resumes download of the content until the requested download is complete (430) and the process ends (445).

If, for example, the downloaded content is streaming data, the remote storage provider stores the downloaded streaming data in the same manner as it is received. For example, if a file was streamed to the remote storage provider in 1000 different packets. The remote storage provider stores the 1000 packets in one or more remote caches and maintains the timing information of each stored packet. In some embodiments, the remote storage provider stores the 1000 packets as a complete data file, but creates object meta data that allows retransmission of the data filed in the manner (e.g., same timing between packets and number of packets) it was received from the content provider.

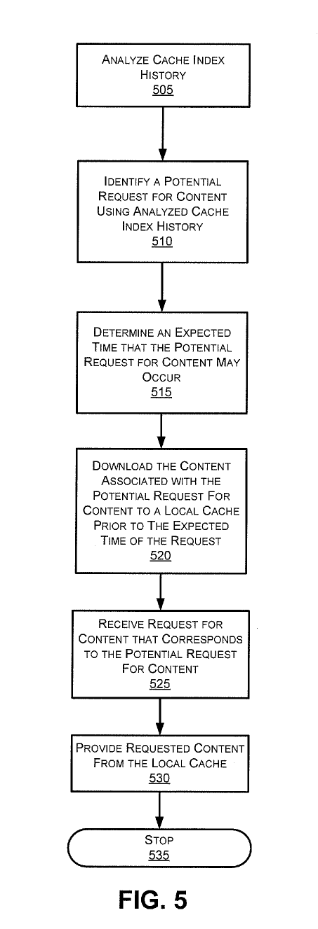

FIG. 5 is a flowchart representing an exemplary method for predictively populating a local cache with content performed by a cache control system (e.g., cache control system 200). Without departing from the exemplary embodiments, the exemplary process flow can be altered to delete steps, change the order of steps, or include additional steps.

The cache control system first analyzes (505) a cache index history to determine any periodic variation or specific trends in content requests. For example, analysis of the cache index history may indicate that the user utilizes various applications that request content every morning between 8:00 and 10:00 am. The cache index history contains a chronological sequence of the cache index IDs requested by a user of a particular application.

The cache control system then identifies (510) an expected request for content using the analyzed cache index history. Continuing from the above example, one of the various applications may be an application the user uses to access an associated social media account.

The cache control system then determines (515) an expected time that the expected request for content may occur. The expected time, may be an exact time or period of time. Continuing from the above example, the cache control system then identifies that the user is expected to access the social media account between 8:00 and 10:00 am.

The cache control system then downloads (520) the content associated with the expected request for content to a local cache prior to the expected time of the content request. Additionally, in some embodiments, the cache control system monitors the one or more networks available to the user's mobile device. If there are a plurality of networks (e.g., Wi-Fi, cellular, etc.) available to the mobile device, the cache control system may select a network, of the plurality of networks, based on bandwidth of the network, cost of use for that network, user selection, or some combination thereof.

At some later point in time, the cache control system receives (525) a request for content from the user that corresponds to the content cached as a result of the expected request for content. The cache control system then provides (530) the requested content from the local cache and the process stops (535).

Additionally, in some embodiments not shown, the cache control system may take into account any cost associated with proactive caching of content. For example, if network fees are more to proactively retrieve the data then access it from the content provider during the expected time of the content request, the cache control system may simply wait until it receives the content request before downloading the content.

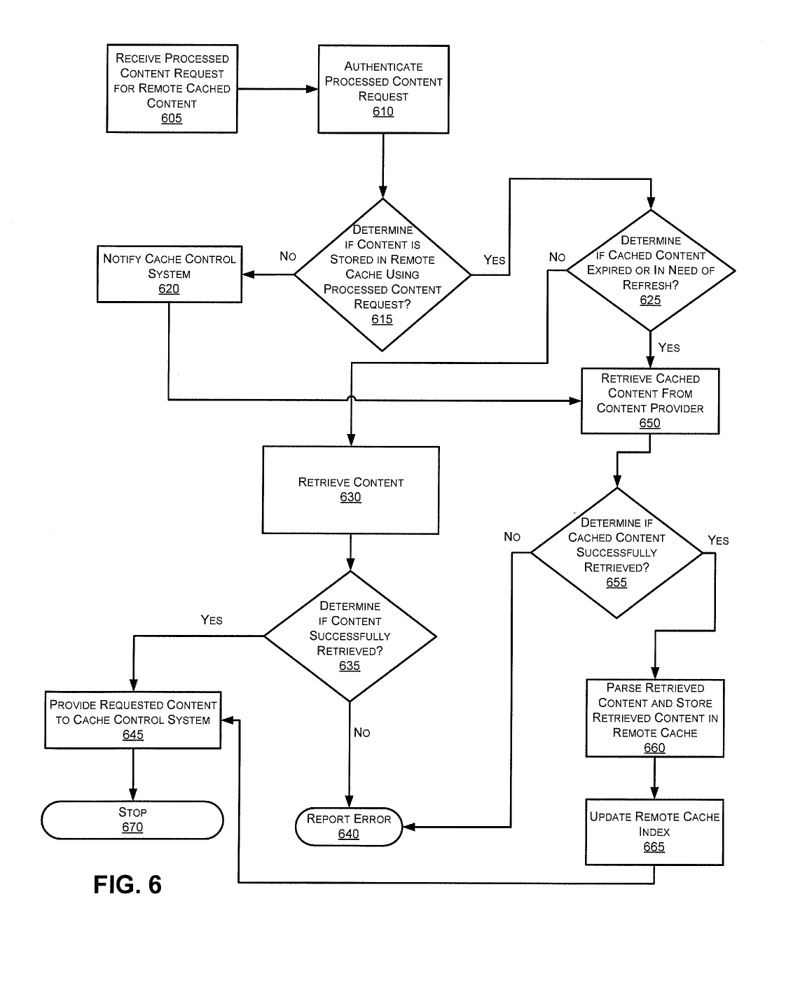

FIG. 6 is a flowchart representing an exemplary method for retrieving content using a remote storage provider (e.g., remote storage provider 140) in communication with a cache control system (e.g., cache control system 200). Without departing from the exemplary embodiments, the exemplary process flow can be altered to delete steps, change the order of steps, or include additional steps.

In step 605, the remote storage provider receives a processed content request for remote cached content from the cache control system of a user's mobile device.

The remote storage provider then authenticates (610) the processed content request using the authentication information included with the request. For example, the user may match the request to information stored in a registered user database (e.g., correct encryption key, correct password, etc.).

And in step 615, the remote storage provider determines if the requested content is stored in a remote cache associated with the user using the processed content request. For example, the remote storage provider may compare the processed content request with the index metadata stored in the user's remote cache index. A match indicates that the requested content is present in the remote cache. Otherwise the remote storage provider notifies (620) the cache control system that the content is not remotely cached.

The remote storage provider then retrieves (650) the requested content from a content provider. In some embodiments, the cache control system monitors the one or more networks available to the user's mobile device. If there are a plurality of networks (e.g., Wi-Fi, cellular, etc.) available to the mobile device, the cache control system may select a network, of the plurality of networks, based on bandwidth of the network, cost of use for that network, user selection, or some combination thereof. The cached content may then be retrieved from the content provider using the selected network.

The remote storage manager then determines (655) if the cached content has been successfully retrieved. If the requested content has not been successfully retrieved, the remote service provider reports (640) the error to the cache control system. If the requested content has been successfully retrieved, in step 660, the remote storage provider parses the retrieved content to obtain index metadata and stores the retrieved content in the remote cache. The remote service provider then updates (665) the user's remote cache index, provides (645) the requested content to the cache control system, and the process stops (670).

Referring back to step 615, if the requested content is stored in the remote cache, the remote storage provider then determines (625) if the cached content is expired or in need of refresh. If the requested content has expired or is in need of refresh the process proceeds to step 650, and proceeds as discussed above. Otherwise, the remote storage provider retrieves (630) the requested content from the remote cache. In step 635, the remote storage provider then determines (635) if the cached content has been successfully retrieved. If the requested content has not been successfully retrieved, the remote service provider reports (640) the error to the cache control system. If the requested content has been successfully retrieved, the remote storage provider provides (645) the requested content to the cache control system, and the process stops (670).

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

In the preceding specification, the subject matter has been described with reference to specific exemplary embodiments. It will however, be evident that various modifications and changes may be made without departing from the broader spirit and scope of the subject matter as set forth in the claims that follow. The specification and drawings are accordingly to be regarded as illustrative rather than restrictive. Other embodiments of the disclosure may be apparent to those skilled in the art from consideration of the specification and practice disclosed herein.

The work that led to the development of the subject matter described herein, was co-financed by Hellenic Funds and by the European Regional Development Fund (ERDF) under the Hellenic National Strategic Reference Framework (ESPA) 2007-2013, according to Contract no. MICRO2-08.

What is claimed is:

1. A method comprising:
receiving a content request from an application on a mobile device;
processing the content request to obtain a processed content request;
comparing the processed content request to index metadata to determine the location of the content;
retrieving the content from the determined location;
updating the cache index; and
providing the requested content to the application.

2. The method of claim 1, wherein
the mobile device includes a local cache, and the determined location is a remote cache located on a remote storage provider; and
the method further comprising updating the local cache with the retrieved content.

3. The method of claim 2, wherein
the retrieved content is streaming data, and
providing the requested content to the application comprises streaming the requested content from the remote cache to the mobile device in the same manner the streaming data was originally stored in the remote cache.

4. The method of claim 2, wherein the processed request for content includes authentication information associated with a user of the mobile device.

5. The method of claim 1, further comprising:
analyzing a cache index history to identify an expected request for content;
determining an expected time associated with the expected request for content;
wherein the retrieved content corresponds to the expected request for content, and retrieving the content from the determined location occurs prior to the expected time; and
updating the local cache with the retrieved content, and
wherein the requested content is provided from the local cache.

6. The method of claim 2, further comprising:
selecting a network, of a plurality of networks available to the mobile device, to utilize for retrieving the requested content

7. A non-transitory computer readable medium storing instructions that, when executed by a mobile device, cause the mobile device to perform a method, the method comprising:
receiving a content request from an application on the mobile device;
processing the content request to obtain a processed content request;
comparing the processed content request to index metadata to determine the location of the content;
retrieving the content from the determined location;
updating the cache index; and
providing the requested content to the application.

8. The computer readable medium of claim 7, wherein
the mobile device includes a local cache, and the determined location is a remote cache located on a remote storage provider; and
the method further comprising updating the local cache with the retrieved content.

9. The computer readable medium of claim 8, wherein the
the retrieved content is streaming data, and
providing the requested content to the application comprises streaming the requested content from the remote cache to the mobile device in the same manner the streaming data was originally stored in the remote cache.

10. The computer readable medium of claim 8, wherein the processed request for content includes authentication information associated with a user of the mobile device.

11. The computer readable medium of claim 7, further comprising:
analyzing a cache index history to identify an expected request for content;
determining an expected time associated with the expected request for content;
wherein the retrieved content corresponds to the expected request for content, and retrieving the content from the determined location occurs prior to the expected time; and
updating the local cache with the retrieved content, and
wherein the requested content is provided from the local cache.

12. The computer readable medium of claim 8, further comprising:
selecting a network, of a plurality of networks available to the mobile device, to utilize for retrieving the requested content

13. A mobile device comprising:
cache manager module configured to:
receive a content request from an application on the mobile device;
process the content request to obtain a processed content request;
compare the processed content request to index metadata to determine the location of the content;
a storage manager module configured to:
retrieve the content from the determined location;
wherein the cache manager module is further configured to:
update the cache index; and
provide the requested content to the application.

14. The mobile device of claim 13, further comprising
a local cache; and
wherein the determined location is a remote cache located on a remote storage provider; and
wherein the cache manager module is further configured to update the local cache with the retrieved content.

15. The mobile device of claim 14, wherein the
the retrieved content is streaming data, and
wherein the cache manager is further configured to provide the requested content to the application comprises streaming the requested content from the remote cache to the mobile device in the same manner the streaming data was originally stored in the remote cache.

16. The mobile device of claim 14, wherein the processed request for content includes authentication information associated with a user of the mobile device.

17. The mobile device of claim 13, further comprising:
a user pattern module configured to:
analyze a cache index history to identify an expected request for content;
determine an expected time associated with the expected request for content,
wherein the retrieved content corresponds to the expected request for content, and retrieving the content from the determined location occurs prior to the expected time; and
wherein the storage module is further configured to update the local cache with the retrieved content, and
wherein the requested content is provided from the local cache.

18. The mobile device of claim 17, wherein the cache manager module 250 is further configured to select a network, of a plurality of networks available to the mobile device to utilize for retrieving the requested content

19. A method comprising:
receiving a processed content request from a cache control system;
authenticating the processed content request to determine if the processed request is associated with a user, wherein a remote cache is associated with the user;
comparing the processed content request to index metadata to determine if the content is stored in a cache associated with the user;
retrieving the content from the remote location; and
providing the requested content to the cache control system.

20. The method of claim 19, wherein the
the retrieved content is streaming data, and
providing the requested content to the cache control system comprises streaming the requested content from the remote cache to the mobile device in the same manner the streaming data was originally stored in the remote cache.
